(19) United States
(12) Patent Application Publication
(10) Pub. No.: US 2018/0122008 A1
(43) Pub. Date: May 3, 2018

(54) ELECTRONIC TRADING SYSTEM AND METHOD FOR MUTUAL FUNDS AND EXCHANGE TRADED FUNDS

(71) Applicant: TSX INC., Toronto (CA)

(72) Inventor: Michael NIEJADLIK, Toronto (CA)

(21) Appl. No.: 15/799,147

(22) Filed: Oct. 31, 2017

Related U.S. Application Data
(60) Provisional application No. 62/415,725, filed on Nov. 1, 2016.

(51) Int. Cl. G06Q 40/04

(52) U.S. Cl. CPC G06Q 40/04; G06Q 10/087

(57) ABSTRACT

Data messages representative of orders for funds are received via a network from market participant terminals. Each data message contains a fund identifier, an indication of a number of units, and a market-participant identifier. Pending orders for mutual funds and exchange traded funds (ETFs) are generated from the data messages. A permissions matrix can be used to restrict pending orders to permitted market participants. Pending orders are accumulated for an indeterminate amount of time in batches. An indication of price is received for each of the funds from remote systems. Preferred fill times for the market participants can be obtained from a fill preference matrix, and accumulated orders are filled according to any preferred fill times.

### CROSS-REFERENCE TO RELATED APPLICATION

This application claims the benefit of U.S. Provisional Patent App. 62/415,725, filed Nov. 1, 2016, which is incorporated herein by reference.

### FIELD

This disclosure relates to electronic trading systems and related methods.

### BACKGROUND

Known trading systems are often specifically designed for a particular type of financial instrument or interest. This can be due to differing regulations and differing technologies used. It is non-trivial to adapt such existing trading systems to new or different financial instruments or interests.

In an example known equity marketplace, dealers submit orders on behalf of one or more retail end-investors through their front-office systems. Positions are aggregated and registered at a clearing and settlement service in the name of the dealer. The dealer's back-office maintains individual investor's positions and manages entitlements and tax reporting. Mutual funds, on the other hand, are typically processed through separate fund transaction processing systems. As such, most dealers have separate front-office systems for managing mutual funds and equities, without sufficient integration among such systems, which can make transacting in mutual funds a very manually intensive and laborious process for a dealer who mainly works with equities.

Exchange traded funds (ETFs) are often traded in a similar manner as equities. When ETF trading is implemented on trading systems designed for equities, bid/ask spreads can discourage market participants who simply want to acquire a position without paying an undue premium. Certain ETF mandates increase risk to the market maker necessitating wider bid/ask spreads. On such systems, market makers must price and maintain orders, despite the fact that funds are typically valuated each day by an issuer, custodian, or valuator. Market makers must also carry inventory to meet matching orders made by other market participants.

As such, conventional systems for electronic trading are not well suited for the efficient processing of mutual funds and certain ETF mandates.

### SUMMARY

According to various aspects of the present invention, data messages representative of orders for funds are received via a network from market participant terminals. Each data message contains a fund identifier, an indication of a number of units, and a market-participant identifier. Pending orders for mutual funds and ETFs are generated from the data messages. A permissions matrix can be used to restrict pending orders to permitted market participants. Pending orders are accumulated for an indeterminate amount of time in batches. An indication of price is received for each of the funds from remote systems. Preferred fill times for the market participants can be obtained from a fill preference matrix, and accumulated orders are filled according to any preferred fill times.

### BRIEF DESCRIPTION OF THE DRAWINGS

The drawings illustrate, by way of example only, embodiments of the present disclosure.

FIG. 1 is a diagram of an overall system.

FIG. 2 is a flowchart of a method for electronic trading.

FIG. 3 is a diagram of an electronic trading system.

FIG. 4 is a diagram of data structures for mutual funds.

FIG. 5 is a diagram of data structures for ETFs.

FIG. 6 is a diagram of a data structure for a fill preference matrix.

FIG. 7 is a diagram of a data structure for a market participant permissions matrix.

FIG. 8 is a flowchart of an exception process.

FIG. 9 is a diagram showing relative timing of the method for electronic purchase of mutual fund units.

FIG. 10 is a diagram showing relative timing of another method for electronic purchase of mutual fund units.

FIG. 11 is a diagram showing relative timing of the method for electronic trading of ETF units.

FIG. 12 is a diagram of a data structure for a commission grid.

FIG. 13 is a flowchart of a balancing process.

### DETAILED DESCRIPTION

The present invention provides an integrated platform for the purchase/redemption of mutual funds and the trading of ETFs together with, optionally, trading of other financial instruments, such as equities. Mutual fund and ETF orders are configured in a manner similar to orders for other financial instruments, such as equities, and are identified and processed according to the techniques described herein. This advantageously allows one trading system to process mutual funds and ETFs in addition to one or more other financial instruments, despite the significant financial and technical differences. Market data feeds can be similarly integrated. In view of the invention, market participants need not maintain separate and distinct systems for mutual funds, ETFs, and other financial instruments. Further, computer processing and memory efficiencies can be gained by using one system.

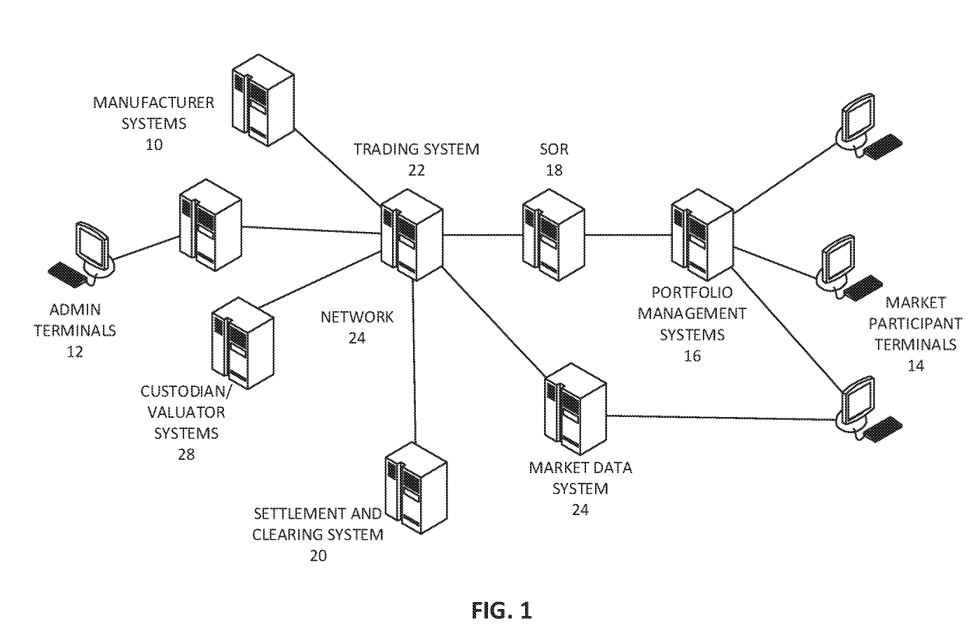

FIG. 1 shows a system according to the present invention. The system includes one or more mutual fund manufacturer systems 10, one or more admin terminals 12, a plurality of market participant terminals 14, one or more portfolio management systems 16, one or more smart order routers and/or order management systems 18, a settlement and clearing system 20, an electronic trading system 22, a market data system 24, and one or more custodian/valuator systems 28, mutually connected via a network 26. The system can further include other components, such as electronic message gateways (not shown) and similar.

The network 26 can include any number and type of computer networks, such as a local area network (LAN), wide-area network (WAN), virtual private network (VPN), a wireless network, an intranet, and the Internet. The network 26 operates to communicatively couple the components 10-24, while isolating domains of such components 10-24 from one another, where appropriate, and restricting communications between domains.

Each of the mutual fund manufacturer systems 10 can include servers, data stores, or other types of computers within a mutual fund manufacturer's domain and under the control of a mutual fund manufacturer. One or more admin terminals 12 can be connected to a mutual fund manufacturer system 10 to manage and control the systems 10, such as to trigger the transmission of data from the mutual fund manufacturer system 10 to the trading system 22.

The one or more custodian/valuator systems 28 are configured to provide prices for ETFs and store settlement records for trades concerning ETFs. One or more admin terminals (not shown) can be provided to a custodian/valuator system 28 to manage and control the system 28, such as to trigger the transmission of data from the custodian/valuator system 28 to the trading system 22.

The market participant terminals 14 are connected to respective portfolio management systems 16, which are configured to place orders initiated by market participant terminals 14 via the smart order routers and order management systems 18 for execution at the trading system 22. Data messages inbound to the trading system 22 represent orders for financial instruments and interests by market participants in control of the terminals 14, such as dealers and brokers, who buy and sell such instruments and interests on behalf of investors. Other market participants, such as market makers, can also use terminals and 16 to post orders and provide other data to the trading system 22. Examples of financial instruments and interests are discussed below, and notably at least include mutual funds and ETFs.

One or more of the smart order routers and order management systems 18 and the trading system 22 can be configured to require each portfolio management systems 16 to authenticate itself using, for example, a username and password, a digital certificate, or similar. As such, the smart order routers and order management systems 18 and the trading system 22 are aware of the identities of connected market participant terminals 14 and can restrict orders based on market participant identities. For example, a particular mutual fund, ETF, or series thereof may only be open to purchase/trade by specific dealers. A market participant permissions matrix can be applied to achieve this.

The terminals 12, 14 can be electronic devices, such as desktop computers, smart phones, tablet computers, and similar devices that have at least one processor configured to execute instructions stored in memory.

The settlement and clearing system 20 is connected to the trading system 22 and receives data indicative of filled orders from the trading system 22. The settlement and clearing system 20 handles the financial transactions behind the exchange of financial instruments and interests facilitated by the trading system 22. The settlement and clearing system 20 can include servers, data stores, or other types of computers within one or more settlement and clearing domains under the control of one or more settlement and clearing entity.

The trading system 22 includes servers, data stores, or other types of computers within a trading system domain controlled by an exchange or other entity. The trading system 22 is configured to receive data messages representative of orders for mutual funds and ETFs from market participant terminals 14, accumulate such orders, and then fill the orders based on price data, such as net asset value (NAV) price, received from the manufacturer systems 10 and custodian/valuator systems 28. The trading system 22 is also configured to process orders received from market participant terminals 14 for other financial instruments and interests, in a conventional manner. Advantageously, the trading system 22 can process data representative of orders for instruments and interests that are subject to only primary trading (i.e., mutual funds) and also process data representative of orders for instruments and interests that are subject to primary and secondary trading (e.g., ETFs, equities, etc.). As will be discussed, a set of universal techniques are used, so that one trading system 22 can handle such disparate types of data.

The market data system 24 is configured to output one or more market data feeds containing mutual fund, ETF data, and equity data. Equities, ETFs, and mutual funds may be identified by their identifiers (e.g., symbol) and may further include last trade data, such as last traded price and volume. Mutual fund data may further include attributes, such as maximum/minimum volume thresholds accepted for purchase/redemption. An example of a market data feed is shown below in Table 1.

TABLE 1

| | | | Min/Max Volume |
|---|---|---|---|
| | Last Trade | | (or NA for not |
| Symbol | Price | Volume | applicable) |
| ABC | $251.49 | 10000 | NA |
| QRS-M | $150.00 | 500 | 100/NA |
| XYZ (F) | $85.44 | 1000 | NA |

In the illustrative example of Table 1, the feed contains mutual fund data and ETF data integrated with normal equity data. The indicator or tag for a mutual fund, in this example, is “-M”. The indicator or tag for an ETF, in this example, is “(F)”. Each identifier in combination with any corresponding tag is unique, so that specific funds and equities based on the same underlying interest or instrument can be distinguished.

The portfolio management systems 16 and market participant terminals 14 can be configured to consume the market data feeds provided by the market data system 24. Such configuration can include identifying the mutual-fund indicator or tag in the feed and displaying information for mutual funds with the indicator, tag, or some other indication to market participants. Similarly, such configuration can include identifying the ETF indicator or tag in the feed and displaying information for ETFs with the indicator, tag, or some other indication to market participants. The market data system 24 can be configured to reference the market participant permissions matrix and to filter or identify mutual funds/ETFs for presentation to the market participants, so as to hide or identify mutual funds/ETFs that a given market participant is not permitted to purchase/trade. Advantageously, market data is provided in integrated but heterogeneous feeds, in a network efficient and computationally efficient manner, with end points decoding the feeds according to their needs.

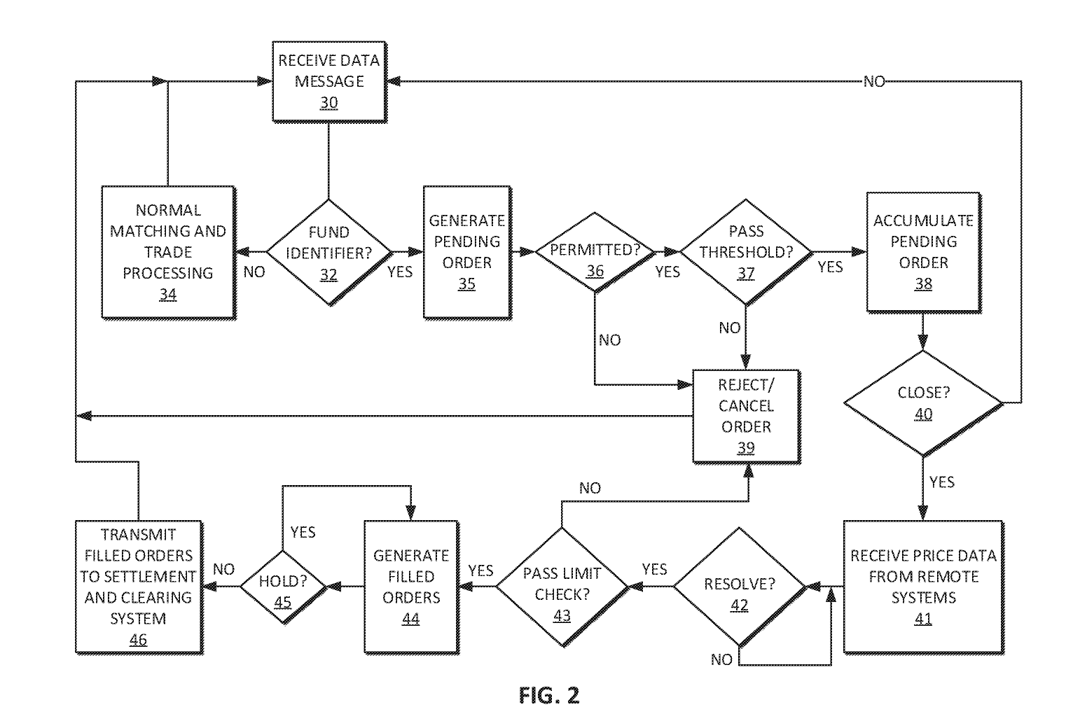

FIG. 2 shows a flowchart of a method performed by the trading system 22.

At step 30 a data message is received at the trading system 22 from one of the market participant terminals 14.

If the data message does not contain a mutual-fund identifier or an ETF identifier, such as a preassigned symbol for the fund similar to a stock symbol, as determined by the trading system 22 inspecting the data message at step 32, then the data message is treated as an order for another kind of financial instrument or interest. The trading system 22 performs matching and trade processing normally for such financial instrument or interest, at step 34.

If the data message contains a mutual-fund identifier or an ETF identifier, then the message is determined to also contain data that includes an indication of a number of units ordered and a market-participant identifier identifying the source of the order. Notably, the data message specifies a number of units (volume) of a mutual fund or ETF, rather than financial information such as a total spend or a price of the fund. The data message may include a limit price that triggers cancellation of the order after determination of a NAV price that contravenes the limit.

At step 35, the trading system 22 extracts data from the data message and uses it to generate a pending order that contains the market-participant identifier, the indication of the number of units, and an identifier of the mutual fund manufacturer or the ETF issuer. The manufacturer/issuer identifier can be obtained by the trading system 22 querying a database to obtain the manufacturer/issuer identifier using the mutual-fund or ETF identifier as a query key, where such database stores relationships of mutual-fund and ETF identifiers to manufacturer and issuer identifiers. Generating a pending order is performed without matching price or time of the respective data message with a corresponding booked order. Rather, each order is automatically generated identifying the correct manufacturer/issuer irrespective of the price, which is not yet known.

At step 36, a market participant check is performed with reference to a market participant permissions matrix. The check is configured to determine whether the market participant specified in the data message is permitted to purchase/trade the fund designated by the identifier contained in the message. If the market participant is not permitted, then the order is rejected at step 39, the message is discarded, and step 30 continues for other received messages. A notification of the reason for order rejection may be transmitted, at step 39, to the relevant portfolio management system 16. If the market participant is permitted, the method continues. In other embodiments, the data message is checked against the permissions matrix and non-permitted orders are not generated (i.e., step 36 is performed before step 35).

At step 37, it is determined whether a minimum volume threshold applies and whether a maximum volume threshold applies. For each such threshold that applies, the threshold is checked and any pending order violating the threshold is rejected, via step 39. That is, if a pending order has a volume that exceeds a maximum volume threshold for the ordered fund, then the pending order is rejected. Likewise, if a pending order has a volume that is less than a minimum volume threshold for the ordered fund, then the pending order is rejected. Such thresholds may be set by fund manufacturers/issuers to introduce volume discounts or tiered pricing using volume as a proxy for the type of client submitting the instruction. If the volume threshold check fails, then the order is rejected at step 39, the message is discarded, and step 30 continues for other received messages. A notification of the reason for order rejection may be transmitted, at step 39, to the relevant portfolio management system 16.

At step 38, the pending order is accumulated by the trading system 22 and stored in a batch with other pending orders for an indeterminate amount of time, which can be based on a selected fill time (e.g., same day, next day, etc.). Accumulating orders involves collecting and storing orders for a time and is distinct from aggregating orders, which instead groups orders based on another characteristic. The present invention does not aggregate orders or processed orders in aggregation. Rather, each order is processed individually after a group of orders are accumulated over a period of time. Orders for mutual funds are accumulated based on fund identifier for eventual purchase/redemption with the respective manufacturer, while orders for ETFs are accumulated based on fund identifier and position for eventual filling by a market maker.

Steps 30-39 are repeated for various messages received throughout the trading day. Step 40 determines whether the trading day has ended and proceeds to step 41 if so.

At step 41, after trading closes and before a deadline during the trading day, the trading system 22 receives an indication of price for each of the mutual funds identified in pending orders from the respective mutual fund manufacturer systems 10. Further, the trading system 22 receives, respective custodian/valuator systems 28, an indication of price for each of the ETFs identified in held orders from the previous trading day. The trading system 22 can query the respective systems 10, 28 for price data. Alternatively, the trading system 22 can wait for such data to be delivered by the systems 10, 28. The price data can be representative of NAV prices.

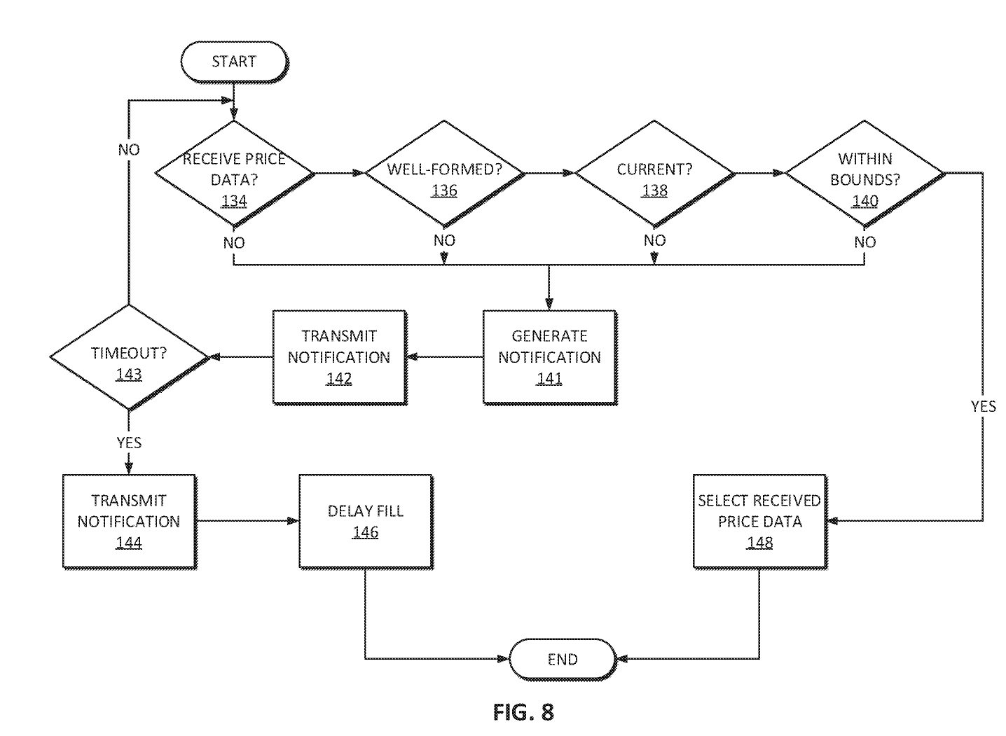

Reception of suitable price data is checked for by an exception process (FIG. 8). The exception process includes checking that the price data meets basic requirements (e.g., exists, is well formed, and is complete).

Step 42 determines whether the accumulated orders are to be resolved, as based on the selected fill time. In one example, the selected fill time is 7:00 PM of the same trading day. In another example, the selected fill time is 8:00 AM of the next trading day. The selected fill time can be selected differently for each market participant. Such selections can be stored at the trading system 22 in a fill preference matrix. Before the selected fill time, step 42 waits. On or after the selected fill time, step 42 resolves accumulated orders by advancing to step 43. Accordingly, steps 43-46 are performed for various market participants based on their selected fill times. For example, one market participant may wish to have orders resolved at the end of the trading day, while another market participant may wish to have orders resolved during the next trading day.

At step 43, for each accumulated pending order that specifies a limit price, the limit price is compared to the obtained NAV price and the accumulated pending order is cancelled, via step 39, if the limit price is contravened. Notification of the reason for order cancellation may be transmitted, at step 39, to the relevant portfolio management systems 16.

Next, at step 44, the trading system 22 calculates a total price based on the relevant received indication of price and the number of units specified in each accumulated pending order to generate a filled order. Accumulated orders for mutual funds are transmitted to respective manufacturer systems 10. Accumulated orders for ETFs are transmitted to respective systems 14, 16 of market makers. Step 44 may reference a commission grid, discussed in detail below, to compensate market makers.

Step 45 determines whether the order relates to an ETF for the current trading day by inspecting the identifier and any tag and the timestamp. ETF orders made during the current trading day are held until the next trading day, so as to provide market makers with sufficient time to obtain inventory to fill such orders.

Filled orders are then transmitted to the settlement and clearing system 20, at step 46. ETF orders for a given trading day are released from step 45 during the next trading day and are filled using the NAV of the next trading day.

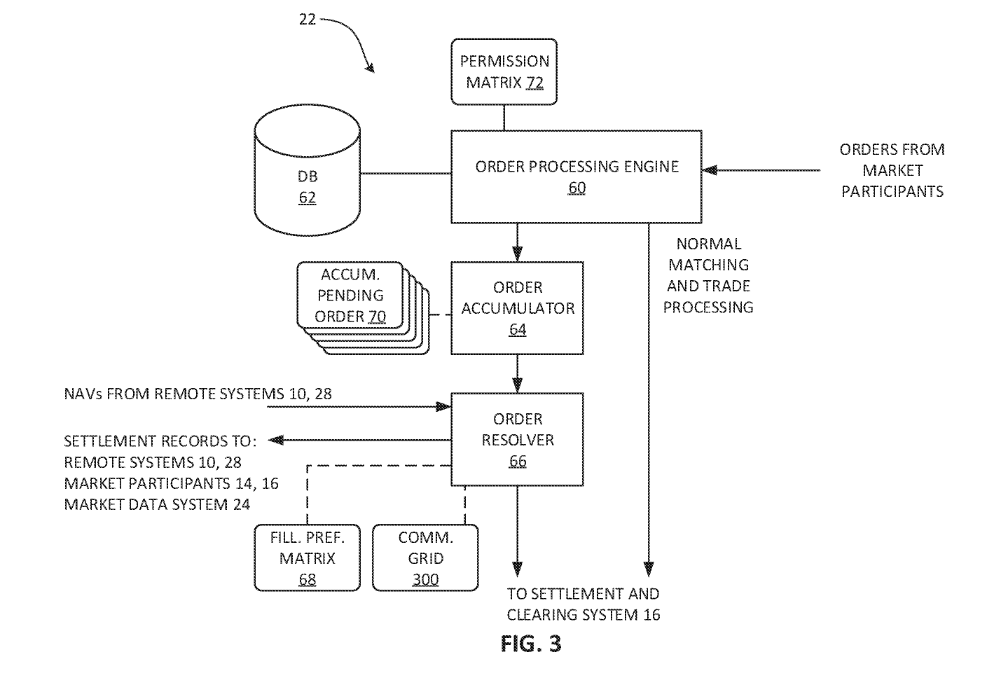

FIG. 3 shows components of the electronic trading system 22.

The trading system 22 includes an order processing engine 60, a database 62, an order accumulator 64, and an order resolver 66. Each of the components 60-64 can include a combination of hardware processors and memory and programmatic instructions to implement the discussed functionality. Functionality of the components 60-64 can be combined into fewer components or further separated into more components, with the components 60-64 being illustrative and not limiting.

The order processing engine 60 is configured to receive data messages via a network 26 from market participant terminals 14 via portfolio management systems 16. Each data message is representative of an order for a financial instrument or interest, including mutual funds and ETFs. In the case of mutual funds, a data message contains a mutual-fund identifier, an indication of a number of units, and a market-participant identifier. In the case of ETFs, a data message contains an ETF identifier, an indication of a number of units, and a market-participant identifier. Because the system operates on a unit-basis, such a data message can omit a price, a total amount to spend, and similar information. A data message can include a limit price.

The order processing engine 60 can be configured to perform matching and trade processing normally for financial instruments and interests other than mutual funds and ETFs. That is, an incoming order for an equity instrument (e.g., a stock) can be matched to another order to create a trade, which is then executed. Such processing is performed by the order processing engine 60 in parallel to processing of mutual fund and ETF orders and thus bypasses the order accumulator 64 and order resolver 66. The order processing engine 60 can be configured to differentiate orders for mutual funds and ETFs from other financial instruments and interests by detecting a mutual-fund or ETF indicator or tag in data messages, such mutual-fund or ETF indicator being within the mutual-fund or ETF identifier (e.g., symbol) or as an attribute of orders contained in the data messages.

The order processing engine 60 is further configured to generate pending orders for mutual funds and ETFs based on received data messages. Each pending order contains a market-participant identifier extracted from a particular data message and an indication of a number of units extracted from the particular data message. For mutual funds, each pending order further includes a mutual fund manufacturer identifier obtained by using the mutual-fund identifier extracted from the particular data message as a key to query the database 62, which stores relationships of mutual-fund identifiers to mutual fund manufacturer identifiers. For ETFs, each pending order further includes a position identifier that signifies whether the order is to buy or sell the ETF to facilitate matching with complementary orders. Also, in the case of ETFs, market makers can place subscription/redemption orders with issuers to manage their inventories, so as to efficiently handle trades with other market participants. This is done out-of-band with respect to the trading system 22, which considers market makers to be another kind of market participant.

The order processing engine 60 can enforce market participant permissions using a permissions matrix 72, as discussed above, to reject non-permitted pending orders. The order processing engine 60 can further implement minimum and maximum volume (unit) thresholds, discussed above, to reject pending orders that contravene any such threshold(s) set for a particular fund.

The order accumulator 64 is coupled to the order processing engine 60 and is configured to receive pending orders from the order processing engine 60. The order accumulator 64 is configured to store pending orders for an indeterminate amount of time in a batch of accumulated pending orders 70.

The order resolver 66 is coupled to the order accumulator 64. The order resolver 66 is configured to receive an indication of price for each of the mutual funds and ETFs identified in the accumulated pending orders 70 from the respective mutual fund manufacturer systems 10 and custodian/valuator systems 28, and to execute an exception process (FIG. 8) to ensure that suitable price data is available. The order resolver 66 is further configured to fetch accumulated pending orders 70 from the order accumulator 64. For each accumulated pending order, the order resolver 66 calculates a total price based on a respective received indication of price and the number of units specified in the accumulated pending order to generate a filled order. Calculation of total price can include multiplying a received NAV price by the number of units in the order. The order resolver 66 can also be configured to cancel any order that does not meet its limit price, if any. Operation of the order resolver 66 can be governed by a fill preference matrix 68 that is checked for each market participant before the generation of filled orders, so that operation of the order resolver 66 is triggered at specific times for specific market participants. The fill preference matrix 68 can define a selected fill time for each market participant. For example, the selected fill time can specify that orders are to be filled the same day as the trade/purchase took place. Alternatively, the selected fill time can specify that orders are to be filled the trading day following the day that the trade/purchase took place. The order resolver 66 is further configured to output filled orders or settlement records to the settlement and clearing system 20. The fill preference matrix 68 can be configured to be securely exposed to market participant systems 14, 16, so that each market participant can view and modify their preferred fill time.

The order resolver 66 can further be configured to reference a commission grid 300 when computing actual prices for orders based on NAV. The commission grid stores commission values for market makers and can be exposed market participant systems 14, 16 of market makers, so that each market maker can select their own commission values. The order resolver 66 adjusts the price for each fund in the accumulated orders using the commission grid.

In various embodiments, the order resolver 66 is configured to reference the commission grid to select market makers for filling accumulated orders. For each position (buy/sell) of each fund designated in the accumulated orders, the market maker with the smallest commission is selected. For instance, the order resolver 66 iterates through each fund and selects from the commission grid 300 the one market maker that has a commission value closest to zero (or smallest absolute value). In this way, competition can be promoted among market makers.

Orders for mutual funds are filled by the respective manufacturers operating the manufacturer systems 10 (primary trading). Orders for ETFs are filled by another market participant, such as a marker maker, operating one or more market participant terminals 14 and portfolio management systems 16 (secondary trading).

Settlement records are also transmitted to the portfolio management systems 16, and can also be transmitted to the market data system 24 for output in one or more market data feeds.

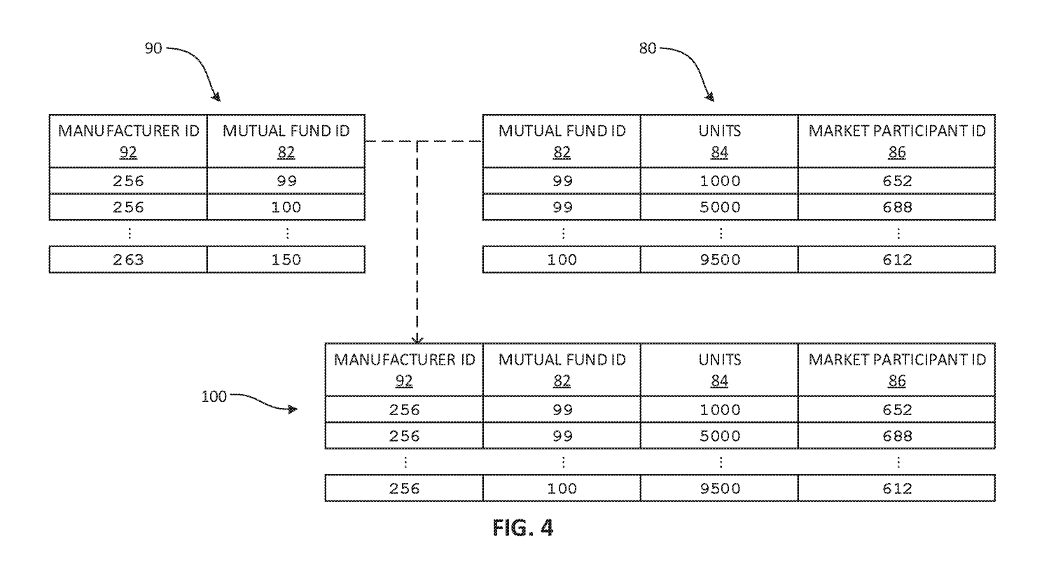

FIG. 4 shows data structures for mutual funds according to the present invention. A message data structure 80 includes fields for mutual-fund identifier 82, number of units 84, and market-participant identifier 86. The data structure 80 can form the basis for data messages representing orders. A fund/manufacturer correlation data structure 90 includes fields for mutual fund manufacturer identifier 92 and mutual-fund identifier 82. The data structure 90 can form the basis of the fund/manufacturer relationships stored in the database 62. An order data structure 100 describes a transaction between two parties and includes fields for mutual fund manufacturer identifier 92, mutual-fund identifier 82, number of units 84, and market-participant identifier 86. The order data structure 100 can be used to store pending and filled orders.

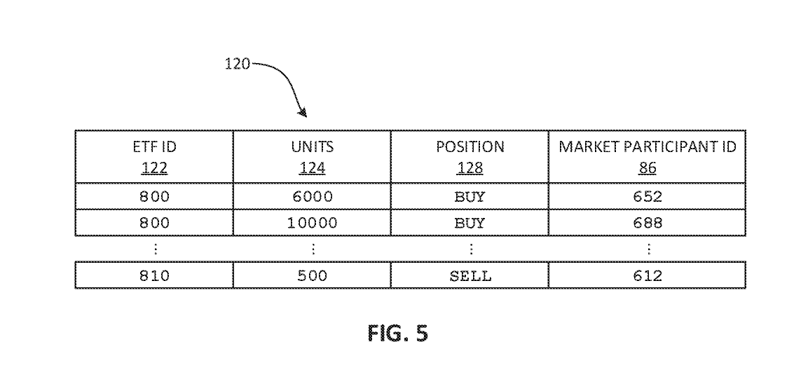

FIG. 5 shows data structures for ETFs according to the present invention. A message data structure 120 includes fields for ETF identifier 122, number of units 124, a market-participant identifier 86, an position indication 128. The data structure 100 can form the basis for data messages representing orders that are to be filled by market makers.

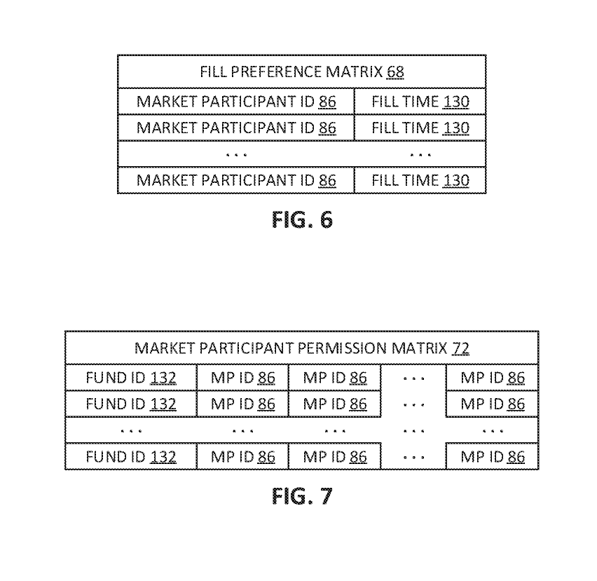

FIG. 6 shows a data structure for the fill preference matrix 68. The fill preference matrix 68 is referenced to determined a fill time 130 for each market participant. It is contemplated that, in the case of mutual funds, dealer/broker market participants select their preferred fill times 130 and other components of the system, such as manufacture systems 10, abide by that preference. That is, manufacture systems 10 provide respective NAVs at times that allow preferred fill times to be met. In the case of ETFs, custodian/valuator systems 28 provide respective NAVs at times that allow preferred fill times 130 to be met. If a NAV cannot be provided by the preferred fill time 130, the exception process of FIG. 8 is performed. Examples of selectable fill time 130 are discussed above (e.g., 7:00 PM of the same trading day, 8:00 AM of the next trading day, etc.). Regardless of the selected fill time and any delay in obtaining the NAV, the NAV used to fill an order is the NAV of the trading day of the order. Market-participant identifiers absent from the fill preference matrix 68 can be assigned a default selected fill time.

FIG. 7 shows a data structure for the market participant permissions matrix 72. Each mutual fund, ETF, or series thereof as identifier by its fund identifier 132, can be correlated to an array of market participant identifiers 86 designating those market participants who are permitted to purchase/trade the mutual fund/ETF. Alternatively, the array of market participant identifiers 86 designate those market participants who not permitted to purchase/trade the mutual fund/ETF. The permissions matrix 72 need not be complete, and market participant identifiers 86 that are not present for a give fund identifier 132 can be set to default to not-permitted or permitted. The market participant permissions matrix 72 is referenced when receiving orders, so that orders by non-permitted market participants can be rejected. The market participant permissions matrix 72 can be configured to be securely exposed to manufacturer systems 10 and/or ETF issuer systems, so that each manufacturer and/or issuer can view and modify permissions associated with their funds.

FIG. 8 shows a flowchart for an exception process used when receiving price data (e.g., NAVs) from manufacturer systems 10 and custodian/valuator systems 28.

The exception process includes, for each mutual fund/ETF identifier (e.g., symbol), checking that data purporting to being price data has been received (step 134) and checking that such data is well-formed (step 136), which can include checking that the message or file containing the data lacks fundamental errors and that the data itself has characteristics of accepted price data (e.g., a monetary value). The data is also checked for currency (step 138), which can include verifying that one or more dates in the data match the current date. Further, a logic check (step 140) may be implemented as another check to ensure that the data lacks other errors. The logic check may include mathematical limits for valid prices (e.g., >0), sensible limits for valid prices (e.g., disallow price moves greater than +/−50%), and similar.

If any of the checks at steps 134-140 fail, then it is determined that the received price data, if any, is invalid and a notification is generated, at step 141. The notification can indicate which check failed. At step 142, the notification is transmitted to the manufacturer system 10 or custodian/valuator system 28 that sent the price data.

Without valid price data for the current trading day, the process repeats, via step 143, until valid price data is received or until a timeout expires. The timeout can be set to a time that is based on the selected fill time of the relevant market participant. For example, for market participants selecting that fills be made on the same trading day, the timeout can be set to 7:00 AM the next trading day. For market participants selecting that fills be made on the next trading day, the timeout can be set to 6:00 PM of that day.

If the timeout expires, it is determined that no valid price data was received. Step 144 transmits a notification to the affected market participant systems 14 and step 146 delays the fill of the affected orders. The affected orders are carried forward to the next trading day, despite any fill time preference, to be filled during the next trading day. The method repeats to obtain valid price data for the actual trading day for any delayed fills.

If all of the checks at steps 134-140 pass, then the received price data is considered valid and is selected as the price data for the current trading day, at step 148.

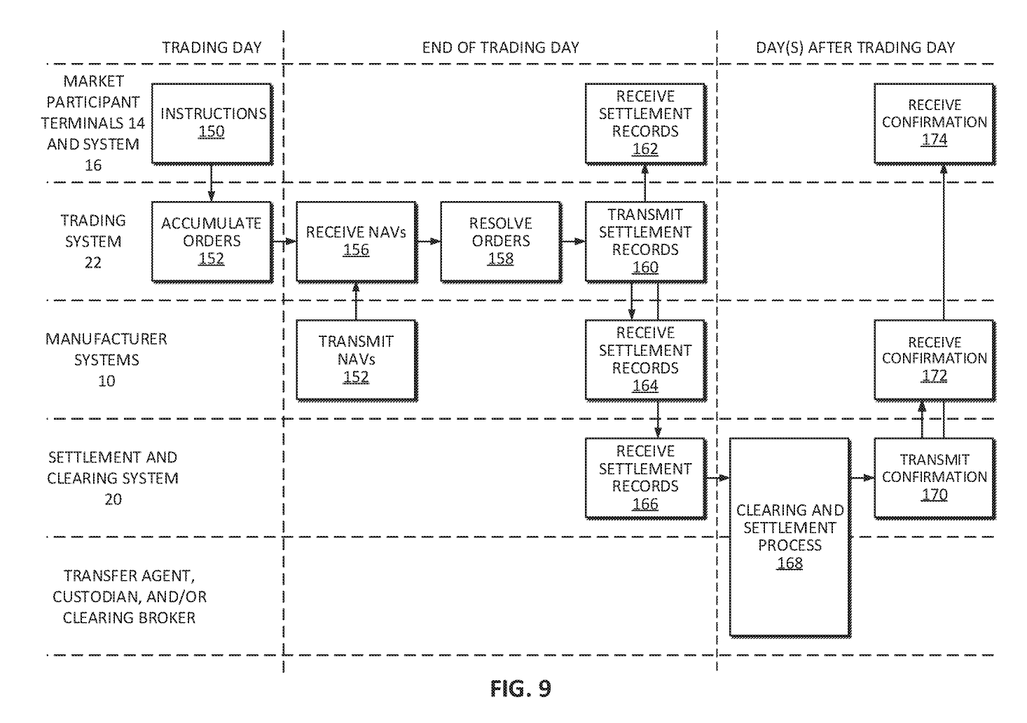

FIG. 9 shows a flowchart diagram illustrating the components of the system that perform each action and showing the timing of each action. The process applies to the purchase and redemption of mutual fund units, though the clearing and settlement process 168 will vary depending on whether purchase or redemption is performed.

During a given trading day, purchase/redemption instructions 150 are generated by the market participant terminals 14 and portfolio management systems 16 and transmitted as orders to the trading system 22. The trading system accumulates orders 152 until the end of the trading day. At the end of the trading day, manufacturer systems 10 transmit 154 NAVs via the network for the trading day to the trading system 22 which receives 156 the NAVs. The trading system 22 resolves 158 the orders, as discussed above, and transmits 160 respective settlement records via the network. The market participant terminals and systems 14, 16, manufacturer systems 10, and settlement and clearing system 20 respectively receive 162, 164, 166 the settlement records or variations thereof. During the next one or more subsequent days, the settlement and clearing system 20, along with one or more transfer agents, custodians, and/or clearing brokers, perform a settlement and clearing process 168 to financially complete each order according to the settlement records. The settlement and clearing system 20 transmits an execution report upon completion, which is receptively received 172, 174 by the manufacturer systems 10 and the market participant terminals and systems 14, 16. The manufacturer systems 10 receiving execution reports 172 can include receiving settlement funds to custodial accounts. The market participants receiving execution reports 174 can include receiving or delivering units, depending on whether units were bought or sold.

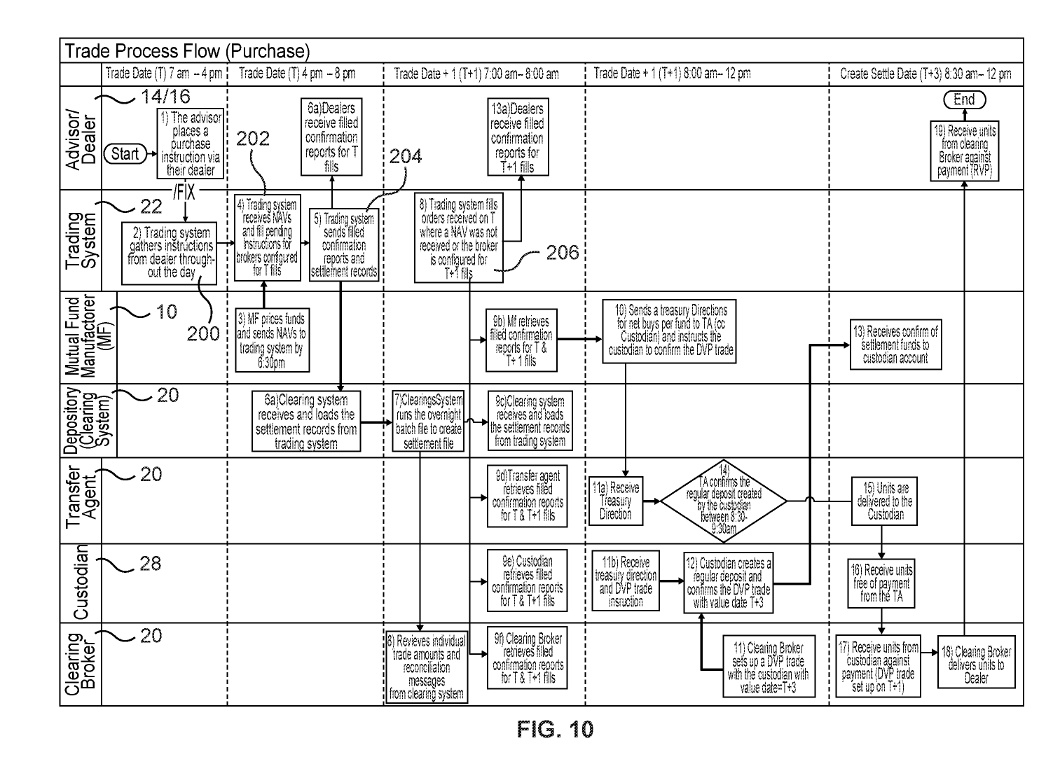

FIG. 10 shows a flowchart diagram illustrating the components of the system that perform each action and showing the timing of each action. The process shows another example for the purchase and redemption of mutual fund units. The components/systems of FIG. 1 that perform the various actions are identified by reference numeral.

At 200, the electronic trading system 22 collects orders from market participant systems 14 and portfolio management systems 16 throughout the trading day. Then, at the end of the trading day, at 202, the trading system 22 receives NAVs from respective manufacturer systems 10 and fills orders for market participants that have selected their fill time to be the same trading day. The trading system 22, at 204, transmits confirmation reports (notifications) and settlement records to the respective market participant systems 14 and the settlement and clearing system 20. Then, during the next trading day, at 206, the trading system 22 fills orders for market participants that have selected their fill time to be the next trading day. The NAV of the actual trading day may have been previously received at 202 or may be received at 206. Also at 206, the trading system 22 fills orders for market participants indicating a preference for same day fills, when the filling of such orders was delayed due to any respective NAVs not being received in time.

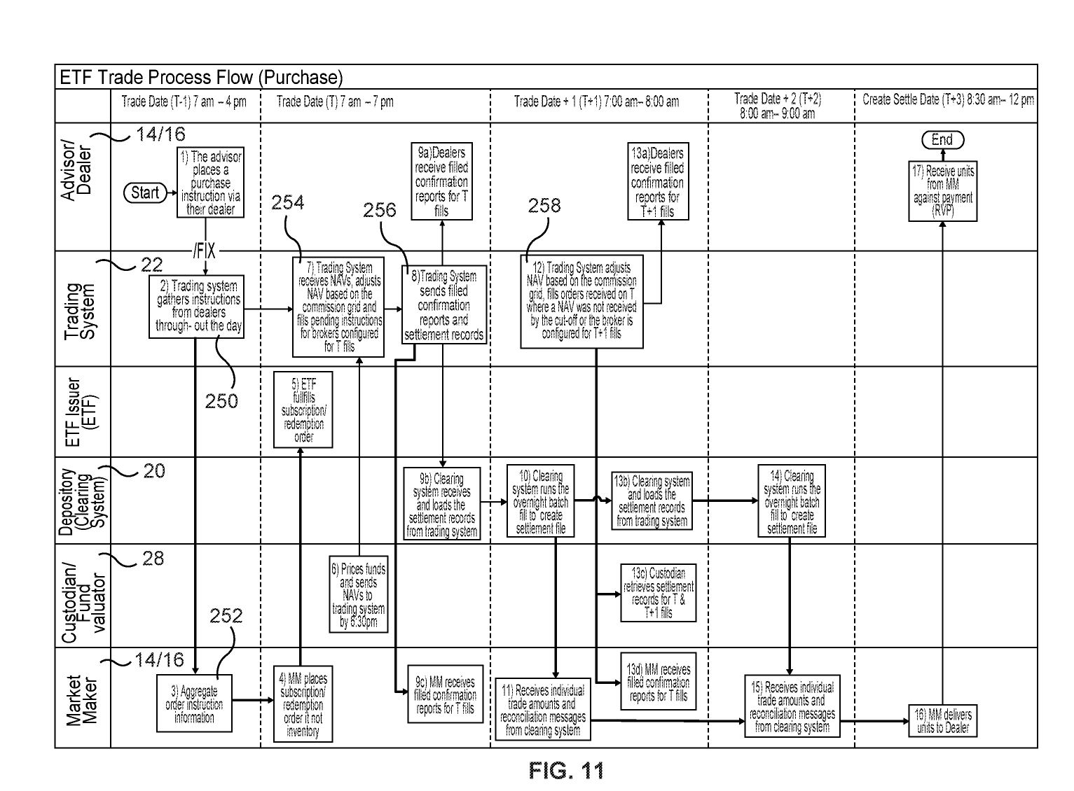

FIG. 11 shows a flowchart diagram illustrating the components of the system that perform each action and showing the timing of each action. The process applies to the trading of ETF units. The components/systems of FIG. 1 that perform the various actions are identified by reference numeral.

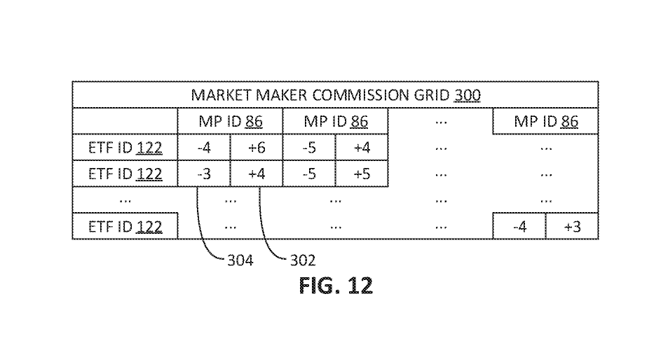

At 250, the electronic trading system 22 collects orders from market participant systems 14 and portfolio management systems 16 throughout the trading day, and transmits, at 252, accumulated order instructions to market makers, who may also operate market participant systems 14 and portfolio management systems 16. Then, at the end of the trading day, at 254, the trading system 22 receives NAVs from respective custodian/valuator systems 28. Further, the trading system 22 releases held orders submitted by market participants during the previous day and fills such orders for market participants that have selected same day fills. The trading system 22 further applies a commission grid (FIG. 12) to the NAV for market makers. The trading system 22, at 256, transmits confirmation reports (notifications) and settlement records to the respective market participant systems 14, including the systems of the dealer/broker trading the ETF and the respective market maker, and to the settlement and clearing system 20. Then, during the next trading day, at 258, the trading system 22 fills orders for market participants that have selected their fill time to be the next trading day. The NAV of the actual trading day may have been previously received at 254 or may be received at 258. Also at 258, the trading system 22 fills orders for market participants indicating a preference for same day fills, when the filling of such orders was delayed due to any respective NAVs not being received in time.

FIG. 12 shows a data structure for a commission grid 300. The trading system 22 references the commission grid 300 when processing ETF fills to obtain commission-adjusted NAV prices for market participants including market makers. That is, a market participant who buys an ETF pays NAV plus a commission to the market maker and a market participant who sells an ETF earns NAV less a commission to the market maker. In the data structure, commissions can be expressed in basis points, with positive denoting an increase to the NAV for buy orders and negative denoting a decrease to the NAV for sell orders. Market makers are thus compensated for their services without having to price and maintain their own orders. The data structure for a commission grid 300 is configured to map market participant identifiers 86 of market makers and ETF identifiers 122 to buy-order commission values 302 and sell-order commission values 304. Hence, each unique combination of market maker and ETF stores distinct commission values. A market maker can thus configure their commissions on a fund-by-fund basis.

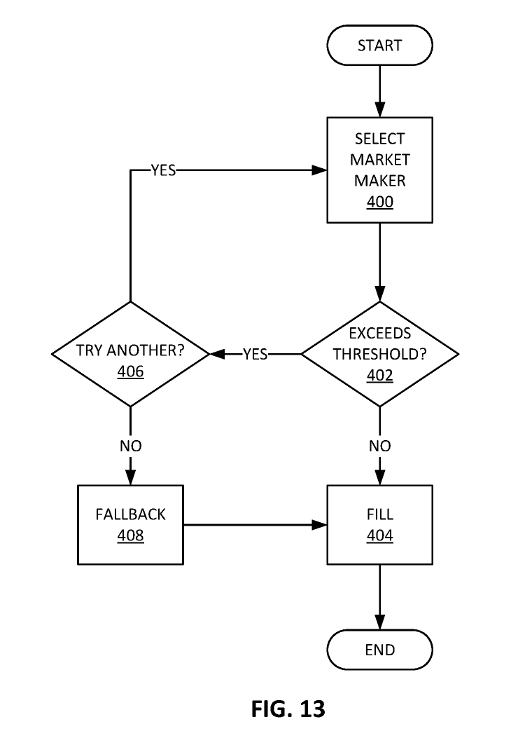

With reference to FIG. 13, a balancing process may be used to limit the exposure of market makers to imbalanced positions. When orders are to be filled, a market maker may be selected based on broker preferencing or other methodology. For example, a given market participant may prefer to have orders filled by a particular market maker. For instance, there may be an existing business relationship that is to be maintained. As such, the market participant may express such preference in their orders.

To prevent a market maker from becoming overexposed to a particular position, the order resolver 66 may be configured to reference an imbalance threshold when filling an order or batch of accumulated orders. A threshold may be defined for each symbol for each market maker. That is, a particular market maker may have a particular threshold for a particular instrument or interest. An imbalance threshold may be set for a group of symbols or for all symbols. When the threshold is exceeded, then a different market maker is selected to fill the order or batch of accumulated orders. The different market maker may be a next preferred market maker based on a preference indicated in an order, a price, or other methodology.

At 400, a market maker is selected to fill an order or batch of accumulated orders. This may be done in accordance with any methodology, such as broker preferencing, price, or a combination of such. The selected market maker's imbalance threshold is then tested, at 402. If the order or batch would not cause the market maker to exceed their limit on the particular position, then the order or batch is filled, at 404. An imbalance threshold may be expressed as a number of units, a dollar value (e.g., units multiplied by unit price), or a similar indication. For example, a market maker may set their imbalance threshold for a particular ETF to 1000 units. If the current exposure of the market maker for the ETF is 950 units and an order or batch indicated 40 units, then the imbalance threshold would not be exceeded, the market maker would fill the order or batch, and their new exposure for the ETF would be 990 units and still below the imbalance threshold.

If, on the other hard, the order or batch of accumulated orders would cause the selected market maker to exceed their limit, then the process determines whether another market maker is available, at 406. If another market maker, who meets order conditions and any other conditions, is available, then that market maker is selected at 400. For example, an order may rank several preferred brokers. In another example, a market maker is selected based on price, but cannot fill the order due to the imbalance threshold, and a market maker with a next-best price is selected. The process loops until a market maker that does not exceed their limit on the particular position is selected and the order or batch is filled at 404.

If no market maker can fill the order or batch, then a fallback process is performed, at 408. The fallback process may be to split the order or batch among several market makers, so that each would contravene their respective imbalance threshold by an amount smaller than if filling the entire order. Any methodology may be used to select several market makers. In one example, the order or batch is split among all market makers offering to fill orders at the same price and who would fill the order but for exceeding the imbalance threshold.

The techniques described above can be implemented in an electronic marketplace or trading system for issuing, trading, holding, transferring, buying, selling, or participating in other types of exchange for one or more financial instrument or interest. Electronic marketplaces and trading systems include one or more electronic networked order books, venues, trading venues, securities trading venues, marketplaces, exchanges, private equity exchanges, public securities exchanges, order books (e.g., dark books, lit books, etc.) within an exchange, alternative trading systems, and/or other markets, alone or in combination. Advantageously, the one or more financial instrument or interest include mutual funds and ETFs, as discussed herein, and may further include securities, debt, shares, stocks, derivatives, and similar or other type of financial product, instrument, or interest. That is, a system according to the present invention processes mutual fund and ETF orders, as discussed, and can be additionally configured to process orders/trades for other financial instruments or interests. The techniques discussed herein can be applied to various computerized trading systems, including those operating in various marketplaces.

While the foregoing provides certain non-limiting example embodiments, it should be understood that combinations, subsets, and variations of the foregoing are contemplated. The monopoly sought is defined by the claims.

1. A method in an electronic trading system, the method comprising:
receiving data messages via a network, the data messages representative of orders for funds from market participant terminals, each data message containing a fund identifier, an indication of a number of units, and a market-participant identifier;
generating pending orders from the data messages, each pending order containing a market-participant identifier extracted from a particular data message and an indication of a number of units extracted from the particular data message;
applying a permissions matrix to data messages or pending orders, the permissions matrix associating market-participant identifiers with fund identifiers, applying the permissions matrix restricting any pending orders for respective funds to permitted market participants;
accumulating the pending orders for an indeterminate amount of time in one or more batches of accumulated pending orders;
receiving an indication of price for each of the funds from one or more remote systems;
obtaining selected fill times for market participants from a fill preference matrix that associates market-participant identifiers with fill times; and
filling accumulated orders according to obtained selected fill times.

2. The method of claim 1, further comprising filling accumulated orders for a particular fund irrespective of any obtained fill times when an indication of price for the particular fund is received after a timeout has elapsed.

3. The method of claim 2, wherein the funds comprise mutual funds.

4. The method of claim 3, wherein the funds comprise exchange traded funds.

5. The method of claim 4, further comprising adjusting the price for each of the funds of the accumulated orders using a commission grid that maps market-participant identifiers of market makers and fund identifiers to commission values.

6. The method of claim 5, further comprising referencing the commission grid to select market makers for filling accumulated orders.

7. The method of claim 1, further comprising referencing an imbalance threshold of a market maker when selecting the market maker to fill accumulated orders.

8. An electronic trading system comprising:
an order processing engine configured to receive data messages via a network, the data messages representative of orders for funds from market participant terminals, each data message containing a fund identifier, an indication of a number of units, and a market-participant identifier;
the order processing engine further configured to generate pending orders, each pending order containing a market-participant identifier extracted from a particular data message and an indication of a number of units extracted from the particular data message;
the order processing engine further configured to apply a permissions matrix to data messages or pending orders, the permissions matrix associating market-participant identifiers with fund identifiers, applying the permissions matrix restricting any pending orders for respective funds to permitted market participants;
an order accumulator coupled to the order processing engine and configured to receive pending orders from the order processing engine, the order accumulator configured to store pending orders for an indeterminate amount of time in one or more batches of accumulated pending orders; and
an order resolver coupled to the order accumulator, the order resolver configured to receive an indication of price for each of the funds from one or more remote systems, the order resolver further configured to obtain selected fill times for market participants from a fill preference matrix that associates market-participant identifiers with fill times and to filling accumulated orders according to obtained selected fill times.

9. The system of claim 8, wherein the order resolver is further configured to fill accumulated orders for a particular fund irrespective of any obtained fill times when an indication of price for the particular fund is received after a timeout has elapsed.

10. The system of claim 9, wherein the funds comprise mutual funds.

11. The system of claim 10, wherein the funds comprise exchange traded funds.

12. The system of claim 11, wherein the order resolver is further configured to adjust the price for each of the funds of the accumulated orders using a commission grid that maps market-participant identifiers of market makers and fund identifiers to commission values.

13. The system of claim 12, wherein the order resolver is further configured to reference the commission grid to select market makers for filling accumulated orders.

14. The system of claim 8, wherein the order resolver is further configured to reference an imbalance threshold of a market maker when selecting the market maker to fill accumulated orders.
